(19) United States
(12) Patent Application Publication
(10) Pub. No.: US 2008/0225456 A1
(43) Pub. Date: Sep. 18, 2008

(54) Overcurrent Protecting Circuit, Motor Drive Circuit, and Semiconductor Device

(76) Inventors: Mitsuaki Daio, Kyoto (JP); Daiki Yanagishima, Kyoto (JP)

Correspondence Address: John R. Mattingly, 1800 Diagonal Road, suite 370, Alexandria, VA, 22314, US

(21) Appl. No.: 10/583,934

(22) PCT Filed: Dec. 20, 2004
(86) PCT No.: PCT/JP2004/019011

§ 371 Date: Jun. 22, 2006

(30) Foreign Application Priority Data
Dec. 26, 2003 (JP) 2003-432778

(51) Int. Cl. H01H 43/02

(52) U.S. Cl. 361/98

(57) ABSTRACT

An over-current protection circuit of a semiconductor circuit including a power transistor for outputting current output, a first output current detection circuit and a current limiter circuit for limiting the output current by stopping the output current of the power transistor for a predetermined period in response to a first detection signal from the output current detection circuit when the output current of the power transistor reaches a predetermined limit value. The over-current protection circuit has an output current detection transistor current-mirror connected to the power transistor and a second output current detection circuit for generating a second detection signal according to an output current of the output current detection transistor when the output current reaches the predetermined limit value. Further, the output current of the power transistor is cut off for the predetermined period by operating the current limiter circuit in response to the second detection signal.

### TECHNICAL FIELD

The present invention relates to an over-current protective circuit, a motor drive circuit and a semiconductor device and, in particular, the present invention relates to an over-current protection circuit of a stepping motor driver of a unipolar (half wave) drive, capable of preventing over-current from flowing to a power transistor when a resistor for detecting output current is short-circuited so that a drive operation of the power transistor can continue.

### BACKGROUND ART

In a unipolar drive type stepping motor driver (pulse motor driver), a gear-shaped rotor is rotated step-by-step by a predetermined angle by sequentially driving a stator of the stepping motor by a single phase drive, a single phase-two phase drive or a two phase drive, etc.

The driver for supplying drive current for driving the stator sequentially includes power transistors (output stage transistors) which are provided correspondingly to respective phases and connected in series with respective exciting coils of the stator, which are connected to a power source line. The stator of the stepping motor is driven by sequentially exciting the exciting coils of the stator by ON/OFF control of the power transistors with a predetermined timing.

When the power transistor of a certain phase is turned ON, the drive current is sequentially increased in the ON period due to transient phenomenon of a predetermined time constant determined by inductance of the exciting coils in the same phase and impedance of the power transistors, etc. In order to limit the increase of the drive current to a predetermined value, the power transistor is controlled such that over-current does not flow through the power transistor by turning the power transistor ON and, after a predetermined time from the time when the power transistor is turned ON, turning it OFF. Therefore, the power transistor is driven such that each phase is chopped by logical pulses of HIGH level “H” and LOW level “L”.

As an example of such pulse drive control, a three-phase motor driver, which is chopper-controlled by setting an ON period of the power transistor by a timer circuit, and a protection circuit of an integrated gate bipolar transistor (IGBT) thereof are well known (Patent Reference 1).

As shown in Patent Reference 1 (JPH11-112313A), the over-current protection circuit of such kind of driver is constructed with a current detection circuit for detecting an output current and an over-current detection circuit for stopping a drive of the power transistor. The current detection circuit is usually provided in series with the power transistor. The over-current detection circuit is activated in response to a detection signal from the current detection circuit, which is obtained when the output current of an output stage power transistor becomes larger than the predetermined value, to limit the output current.

Patent Reference 1: JPH11-112313A

### DISCLOSURE OF THE INVENTION

### Problems that the Invention is to Solve

The simplest design of the current detection circuit for detecting over-current (or limiting the output current) is to provide a resistor, which has a resistance value of 1Ω or smaller, in series with the power transistor. However, when this current detection resistor is short-circuited, the over-current protection circuit (or the current limiter circuit) does not work. Therefore, there is a problem that the power transistor may be damaged.

Further, when the current detection circuit can not output current detection signal by other malfunction by which there is no current detection signal generated in the current detection circuit, the over-current protection circuit does not function similarly to the case of short-circuit of the current detection resistor.

The present invention was made in view of the problems of the prior art and an object of the present invention is to provide a reliable over-current protection circuit, which is capable of continuing a drive operation of the power transistor by preventing an over-current of the power transistor when the current detection resistor is short-circuited, a motor drive circuit having the over-current protection circuit and a semiconductor having the motor drive circuit.

Another object of the present invention is to provide a reliable over-current protection circuit, a motor drive circuit or a semiconductor device, which is capable of continuing a drive operation of the power transistor by preventing an over-current of the power transistor when the current detection resistor is short-circuited or when a circuit for detecting the output current detection circuit malfunctions.

### Means for Solving the Problems

In order to achieve the above objects, an over-current protection circuit of a semiconductor circuit, which includes a power transistor, a first output current detection circuit and a current limiter circuit for limiting output current by stopping the output current of the power transistor for a predetermined period in response to a first detection signal from the output current detection circuit when the output current of the power transistor reaches a predetermined limit value, comprises an output detection transistor current-mirror connected to the power transistor and a second output current detection circuit for generating a second detection signal in response to an output current of the output current detection transistor when the output current of the power transistor reaches a predetermined value larger than the predetermined limit value, wherein the output current of the power transistor is cut off for the predetermined period by activating the current limiter circuit in response to the second detection signal.

### ADVANTAGE OF THE INVENTION

Incidentally, the output current detection resistor of the output current detection circuit is usually a resistor having a small resistance value of 1Ω or smaller. Therefore, when this resistor is short-circuited (a terminal voltage of the resistor becomes 0), the drive circuit itself is not substantially influenced except that the over-current protection circuit or the current limiter circuit does not function. Further, since the output current detection resistor is usually provided externally of the semiconductor circuit, such short-circuit of the output current detection resistor tends to occur.

Therefore, in this invention, the over-current protection is performed by a circuit route provided separately from the output current detection circuit and including an output current detection transistor connected to the power transistor in current-mirror relation and by the existent current limiter circuit. That is, the over-current protection is performed by two systems.

Thus, a protection circuit is constructed with the current limiter circuit for chopping control and the over-current protection circuit.

Particularly, when the exciting coil is connected in series with the power transistor and the output current detection circuit is the resistor connected in series with the power transistor as in the motor drive circuit, the protection circuit functions even when the resistor is short-circuited and the terminal voltage becomes zero (or even when the terminal voltage of the resistor becomes nearly zero due to malfunction of the output current detection circuit). Therefore, the motor driver IC including the over-current protection circuit can prevent over-current continuously and the power transistor is not broken. Consequently, it is possible to protect the motor drive circuit against such malfunction.

The predetermined limit value corresponds to not a value for the over-current protection but a design value for limiting the current value when the motor drive circuit is driven by chopping. Originally, the over-current protection circuit is provided in order to prevent the IC from being damaged. In the present invention, the operation of the over-current protection circuit is set in a range of the operation of the current limiter circuit and, when the working of the current limiter circuit becomes impossible, the over-current protection circuit works as a current limiter circuit. The predetermined current value larger than the rated current is set in a range within which a continuous motor drive operation of the power transistor does not cause any trouble. For example, the current range is larger than the current, at which the current is limited, by 5% to 10%.

Since the rated current value of the power transistor is set as a design value for limiting current with sufficient margin with respect to a critical value in a long term drive similarly to the drive current of a usual power transistor circuit, there is substantially no problem even when the output circuit of the motor drive circuit is set in the range larger than about 5% to 10%.

As a result, it is possible to provide an over-current protection circuit capable of continuing the drive operation of the power transistor by preventing over-current of the output stage when the output current detection resistor is short-circuited and the output current detection circuit malfunctions. Further, it is possible to easily realize a reliable motor drive circuit and a semiconductor device.

### BEST MODE FOR CARRYING OUT OF THE INVENTION

FIG. 1 is a block circuit diagram of a stepping motor driver of unipolar drive according to an embodiment to which an over-current protection circuit of the present invention, FIG. 2 is a timing chart of an operation of the power transistor protective circuit and FIG. 3 is a block diagram of another embodiment of the present invention.

In FIG. 1, a unipolar drive stepping motor driver IC 10 includes current output circuits 1a, 1b, 1c and 1d, which have output terminals 2a, 2b, 2c and 2d connected to single phase exciting coils 11a, 11b, 11c and 11d of a stepping motor 11, respectively.

The exciting coils 11a, 11b, 11c and 11d are connected to a power source line 13 of a power source (battery) 12. Incidentally, flywheel diodes D are connected in parallel to the exciting coils 11a to 11d, respectively.

The power source 12 supplies power to a voltage regulator circuit (REG) 2 provided within the IC through a terminal 2e and the REG 2 applies a stabilized voltage, for example, 12V, to an internal power source line +VDD to thereby supply power to various circuits provided internally of the IC.

The single phase drive circuits 1a to 1d have identical circuit constructions and, therefore, only the current output circuit 1a is shown and described in detail.

The single phase drive 1a is constructed with a power transistor 3, which is an N channel MOSFET, an output current detection transistor 4, which is an N channel MOSFET, for detecting an output current, a current limiter circuit 5 and an over-current detection circuit 6. Incidentally, for simplicity of description, the current limiter circuits 5 of the respective single phase drive circuits are shown outside of the single phase drive circuit 1a.

The power transistor 3 has a drain connected to the output terminal 2a to output an exciting current to the output terminal 2a. A drain of the transistor 4 is connected to the output terminal 2a to form a current mirror circuit with the power transistor 3. Incidentally, the output current of the output terminal 2a is a sink current from the exciting coil 11a.

A source of the power transistor 3 is connected to a terminal 2f. One end of a resistor Rs for detecting the output current provided externally of the IC is connected to the terminal 2f and the other end is grounded.

Channel width (gate width) ratio of the transistor 4 and the power transistor 3 is set to 1: N where N is an integer equal to 2 or larger. Thus, a current, which is 1/(N+1) of the output circuit of the exciting coil 11a, is supplied to the transistor 4.

The current limiter circuit 5 is constructed with a resistor Ro, a comparator 5a and a reference voltage generator circuit 5b. Incidentally, the resistor Ro is provided externally of the IC and constitutes an output current detection circuit. Though the resistor Ro is a portion of the current limiter circuit 5, it can be an independent circuit.

The resistor Ro is connected between the terminal 2f and a (+) input terminal of the comparator 5a and the reference voltage generator circuit 5b is provided externally of the IC and connected to a (−) terminal of the comparator 5a through a terminal 2g. A reference voltage VREF is applied to the (−) terminal of the comparator 5a.

Assuming that a voltage at a connecting point N of the resistor Ro and the comparator 5a is Vs, the comparator 5a generates a detection pulse S when the output current of the power transistor 3 is increased to a value at which the voltage Vs exceeds the reference voltage VREF, in other words, when the output current becomes a predetermined limit value. The detection pulse S is supplied to a chopping pulse generator circuit 7 to make a “H” chopping pulse P OFF (from “H” to “L”) and supplied to an OFF timer circuit 8. Thus, the power transistor 3 becomes OFF during the OFF time determined by the OFF timer circuit 8 will be described in detail later.

Incidentally, in this embodiment, Ro>>Rs. Ro and Rs are resistance values of the resistor Ro and the resistor Rs, respectively, and Rs is 1Ω at most and usually, for example, about 0.3Ω.

A stop time of the chopping pulse P (time for which the chopping pulse is “L”) is counted by the OFF timer circuit 8 and the chopping pulse P becomes “H” after a constant time, for example, 15 μsec (see TOFF in FIG. 2(b)). The chopping pulse P is “H” in a period selected from a range, for example, 30 μsec to 50 μsec. That is, the chopping pulse P is normally “H” and becomes “L” in response to the detection pulse S and, after the constant time, returns to “H”.

As a result, the current limiter circuit 5 limits the output current of the power transistor 3 by stopping the drive current when the voltage Vs at the connecting point N, which is determined by the terminal voltage of the resistor Rs, exceeds the voltage VREF. That is, the current limiter circuit 5 functions to limit the output current of the power transistor 3 by chopping it with an output current value (a predetermined limit value) smaller than the current limit of the over-current detection circuit 6. In the meaning of limiting current, the current limiter circuit works as an over-current protection circuit.

The chopping pulse P, which is normally “H”, is sent to a phase exciting signal generator circuit 9. In the phase exciting signal generator circuit 9, the chopping pulse P is ANDed with a gate drive pulse (“H”) of the single phase drive circuit 1a and outputted to the gate of the power transistor 3 (see FIGS. 2(a) and 2(b)). That is, a chopping pulse, which corresponds to the chopping pulse P and is intermittent at a predetermined frequency for the period in which the gate drive pulse is “H”, is supplied from the phase exciting signal generator circuit 9 to the common gates of the power transistor 3 and the transistor 4. When the chopping pulse P is “L”, the gate drive pulse becomes “L”, so that the power transistor 3 is turned OFF to stop the drive current supply to the exciting coil 11a of the stepping motor 11.

Since the flywheel diodes D are connected in parallel to the respective exciting coils, currents flowing through the exciting coils is switched to the flywheel diodes D in the OFF period TOFF in which the chopping pulse P is “L”. Thus, the current becomes an average current determined by a relation between the ON period and the OFF period of the chopping pulse P.

The chopping pulse generator circuit 7 and the OFF timer circuit 8 are provided commonly for the single phase drive circuits 1a to 1d and the chopping pulses P are generated correspondingly to drives of the exciting coils of the single phase drive circuits 1a to 1d and supplied to the phase exciting signal generator circuit 9.

The phase exciting signal generator circuit 9 generates the gate drive pulses of the power transistors 3 of the single phase drive circuits 1a to 1d correspondingly to the single phase drive, the single—two phase drive or the two phase drive with predetermined timing. In order to limit the drive currents, the “H” periods of the gate drive pulses are chopped by the chopping pulses P, respectively.

The over-current detection circuit 6 is constructed with a resistor R1, an NPN bipolar transistor Q1, a resistor R2 and a current mirror 6a, which is constructed with NPN bipolar transistors Q2 and Q3. The resistor R1 is connected between the source of the transistor 4 and ground GND.

The transistor Q1 for detecting over current has an emitter grounded, a collector connected to a collector of the transistor Q2 through the resistor R2 and a base connected to the source of the transistor 4. The terminal voltage Vb of the resistor R1 is applied to the base of the transistor Q1. When the terminal voltage Vb exceeds 1 Vf (=0.7V, which is the forward voltage between the base and the emitter), the transistor Q1 becomes ON and detects over-current.

The transistor Q2 is an input side diode-connected transistor and connected together with the emitter of the output side transistor Q3 to the power source line +VDD. The collector of the output side transistor Q3 is connected to the connecting point N of the resistor R0 and the (+) input terminal of the comparator 5a.

When the over-current detection circuit 6 operates, current outputted from the collector of the output side transistor Q3 flows through the resistor Ro and the resistor Rs to ground GND to generate a voltage higher than the reference voltage VREF at the connecting point N.

Now, an operation of the over-current detection circuit 6 will be describe with reference to a drive timing chart shown in FIG. 2. Incidentally, in the drive timing chart, left side portions of waveforms show a normal state and right side portions are in a case when the detection resistor Rs is short-circuited.

FIG. 2(a) shows the gate drive pulse of the single phase drive circuit 1a. In the “H” period, current of the power transistor 3 is controlled by chopping. FIG. 2(b) shows the chopping pulse P. When the chopping pulse P is “H”, the drive current flows to the exciting coil 11a of the stepping motor 11, so that the output voltage Vout of the output terminal 2a becomes as shown in FIG. 2(c).

The voltage Vs at the connecting point N, which is usually applied to the (+) input terminal of the comparator 5a, increases up to the VREF and then drops to the ground potential by the operation of the current limit circuit 5 (see FIG. 2(d)). However, when the resistor Rs is short-circuited, that is, when the terminal voltage of the resistor Rs becomes zero, the third and succeeding waveforms (the right side waveforms) disappear. In such case, since there is no voltage at the terminal 2f, the voltage Vs at the connecting point N becomes equal to that when the connecting point N is grounded. Since the over-current detection circuit 6 does not operate yet in this stage, substantially no current flows through the resistor Ro provided between the connecting point N and the terminal 2f. In addition, the current limiter circuit 5 does not perform the current limiting operation. Therefore, the output voltage Vout of the output terminal 2a is increased as shown in FIG. 2(c).

As a result, the output current, which is larger than the current limited by the current limiter circuit 5, flows into the power transistor 3 when the resistor Rs is short-circuited.

When the current exceeding, for example, 2.6 A flows in this case, a corresponding current flows through the transistor 4, causing the terminal voltage Vb of the resistor R1 to be increased (see FIG. 2(e)). Incidentally, it is assumed that the maximum rated current of the power transistor 3 is 3.0 A (>2.6 A).

When the terminal voltage Vb exceeds 1 Vf, the over-current detection circuit 6 starts to operate and the transistor Q1 for detecting over current becomes ON, so that the current detection circuit 6 is operated such that the output side transistor Q3 of the current mirror circuit outputs a current I, which flows to the ground GND through the resistor Ro and the short-circuited resistor Rs (see FIG. 2(f)). The resistance value of the resistor Ro in this case is set such that the voltage Vs at the connecting point N exceeds the voltage VREF by the current I (see FIG. 2(g)).

As a result, the output of the comparator 5a becomes “H” and the chopping pulse P is changed from “H” to “L”. Therefore, the OFF timer circuit 8 is driven and the gate drive pulse becomes “L”. The power transistor 3 is OFF during the OFF period (L period) of the chopping pulse P.

When the power transistor 3 is OFFed, the drive current is cut off and the terminal voltage of the resistor R1 is turned to OFF and the operation of the current drive circuit 6a is terminated (see FIG. 2(e)).

When the chopping pulse P becomes “H” after the OFF time lapses, the power transistor 3 is turned ON to supply the drive current to the exciting coil 11a.

As a result, the exciting coil 11a is driven by the current waveform shown in FIG. 2(h) and the described states are repeated. The output current of the output terminal 2a is a sink current from the exciting coil 11a. Incidentally, in FIG. 2(h), delay, etc., of the current waveform with respect to the output voltage waveform shown in FIG. 2(c) is not considered. In FIG. 2(h), a current II corresponds to the rated current value, which is limited by the current limiter circuit 5 and is, for example, 2.6 A. Further, a current 12 is a current limited by the over-current detection circuit 6 and corresponds to 2.7 A slightly larger than 2.6 A. In either case, the value is set to the maximum rated current at most.

Incidentally, the object of this current limitation is originally not for over-current protection but for limitation of current such that it becomes a designed value for chopping control by selecting the externally provided resistor Rs. It is usual that the current value for over-current protection is set to a value corresponding to the maximum rated current at most. In this embodiment, in order to use the over-current protection circuit when the resistor Rs is short-circuited, the over-current protection current is set to 2.7 A with respect to the current limit of 2.6 A so that the difference between the over-current protection current and the current limit becomes small. Further, in this embodiment, when the current larger than the designed value is considered as over-current, the current limiter circuit 5 becomes a first over-current protection circuit and the over-current detection circuit 6 becomes a second over-current protection circuit, so that the current limiter circuit constructs a 2-stage over-current protection circuit.

Therefore, the stepping motor drive IC 10 operates as the drive circuit even when the resistor Rs is short-circuited and the power transistor 3 is not damaged since the over-current protection circuit 6 operates.

FIG. 3 shows another embodiment of the present invention, which is different from the embodiment shown in FIG. 1 in that the emitter of the transistor Q1 is connected to the terminal 2f and the ground side terminal of the resistor R1 is connected to the terminal 2f. Further, a resistor R3 is provided between the collector of the transistor Q3 and the connecting point N.

According to the embodiment shown in FIG. 3, the construction of the comparator 5a becomes simpler and the over-current protection circuit 6 is positively operated when the output current detection resistor is short-circuited, so that the operation of the over-current protection circuit 6 in the normal state is made difficult due to the voltage of the terminal 2f, which is increased slightly.

The internal circuit of the comparator 5a is not shown in FIG. 1. When the collector of the transistor Q3 is connected to the connecting point N as shown in FIG. 1 and the collector current is inputted to the (+) input terminal of the comparator 5a, the wired OR output with the terminal of the resistor Ro is inputted to the (+) input of the comparator 5a.

Depending upon a circuit construction of the comparator 5a, the operator of this circuit construction may become unstable due to relation between the resistance value of the resistor Ro and the output current value of the transistor Q3. In order to avoid such situation, it is necessary, for example, to construct the internal circuit of the comparator 5a with two comparators to separate the inputs on the side of the resistor Ro from the input on the side of the transistor Q1 or to use a comparator having two (+) input terminals. In such case, the circuit construction of the comparator 5b becomes complicated. However, when the emitter of the transistor Q1 is connected to the terminal 2f and the terminal of the resistor R1 on the ground side to the terminal 2f as shown in FIG. 3, the point at which the detection signal of the respective detection circuits become common. Therefore, it is enough to provide the comparator 5b having a simplified internal circuit. Incidentally, the resistor R3 is provided appropriately.

In these embodiments, the comparator 5a is provided in each of the single phase drive circuits 1a to 1d. However, it is possible to provide the comparator 5a commonly for a plurality of single phase drive circuits. For example, by using a detecting resistor Rs commonly for the single phase drive circuits 1a and 1b and the detecting resistor Rs commonly for the single phase drive circuits 1c and d, it is possible to use only two comparators 5a.

Instead of the MOSFETs. bipolar transistors may be used as the power transistors Tr.

Further, though the motor drive circuit of the unipolar drive stepping motor drive IC was described, the present invention can be applied to a bipolar drive (positive and negative phase drive) stepping motor drive IC by using a push-pull type drive circuit for the output current of the power transistor.

Incidentally, though, in the described embodiments, the over-current detection circuit 6 does not include the transistor 4 for current detection, it is possible that the over-current detection circuit 6 may include the transistor 4. Further, the resistor Ro of the current limiter circuit 5 may be provided on the side of the over-current detection circuit 6.

### INDUSTRIAL APPLICABILITY

The case where the resistor Rs is short-circuited (the terminal voltage of the resistor Rs becomes zero) has been described. Since the current limitation is not performed when the detection signal is not generated or is lower than the reference voltage VREF due to malfunction of the circuit for detecting output current of the power transistor 3 (except a breaking of the output line of the power transistor), a similar phenomenon to the described phenomenon, which occurs when the resistor Rs is short-circuited, occurs. Therefore, the present invention can be applied to the case of the malfunction of the circuit for detecting output current of the power transistor.

Further, though, in the described embodiments, the OFF control of the power transistor 3 is performed by the chopping pulse generator circuit 7 and the OFF timer circuit 8, the chopping pulse generator circuit 7 and the OFF timer circuit 8 are not always necessary provided that the power transistor 3 is OFF controlled.

Further, though the stepping motor drive IC has been described, the present invention is applicable to any drive circuit so long as the drive circuit has a current limiting circuit or an over-current protection circuit for limiting the drive current by the OFF control of the power transistor by using a rated current.

### BRIEF DESCRIPTION OF THE DRAWINGS

FIG. 1 is a block diagram showing an embodiment of a unipolar drive stepping motor driver to which a power transistor protective circuit of a motor drive circuit of the present invention is applied.

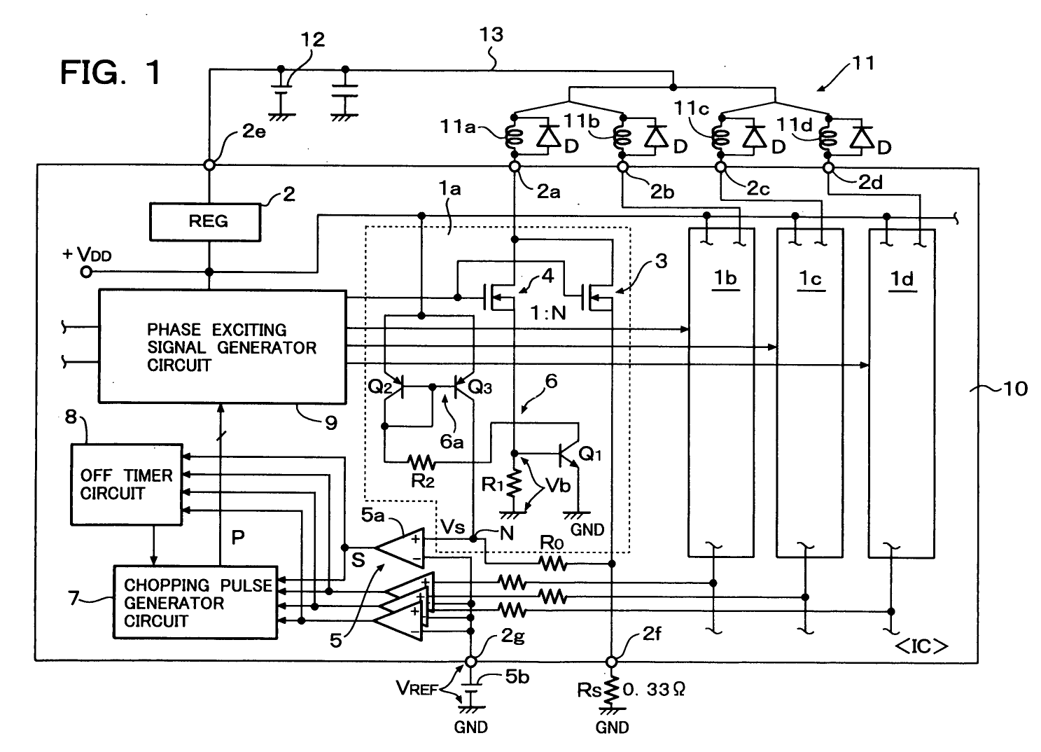

FIG. 2 is a timing chart of an operation of the power transistor protective circuit.

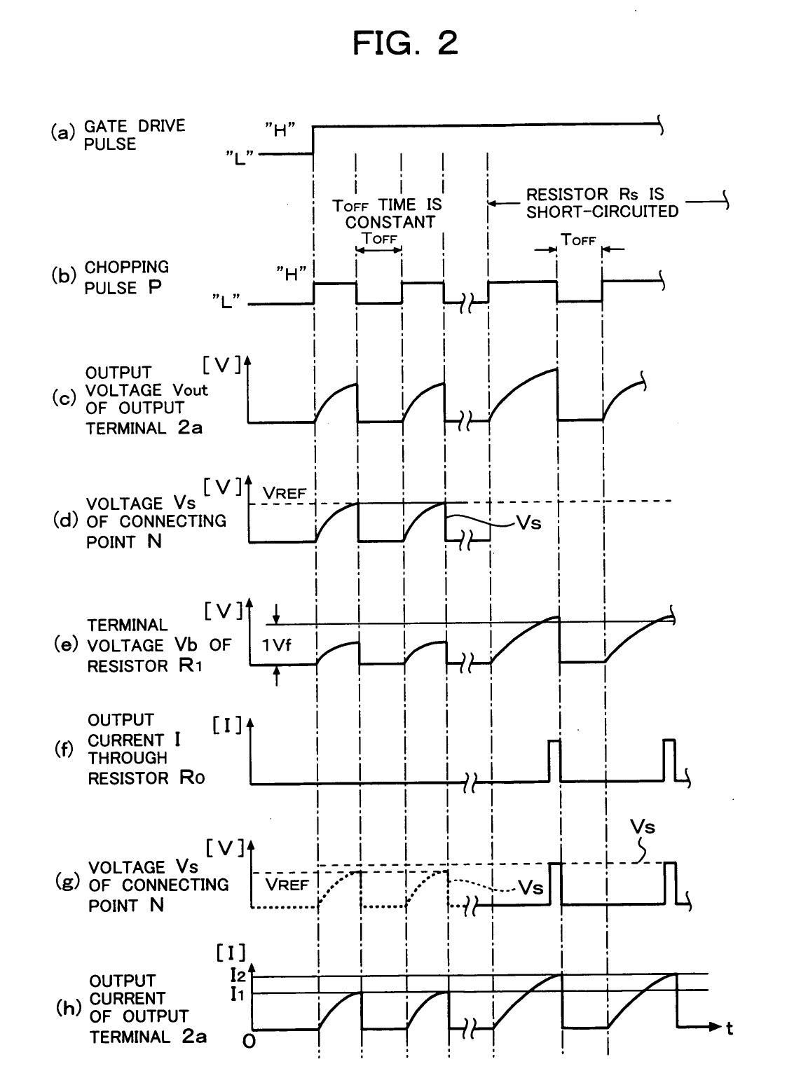

FIG. 3 is a block circuit diagram showing another embodiment of the present invention.

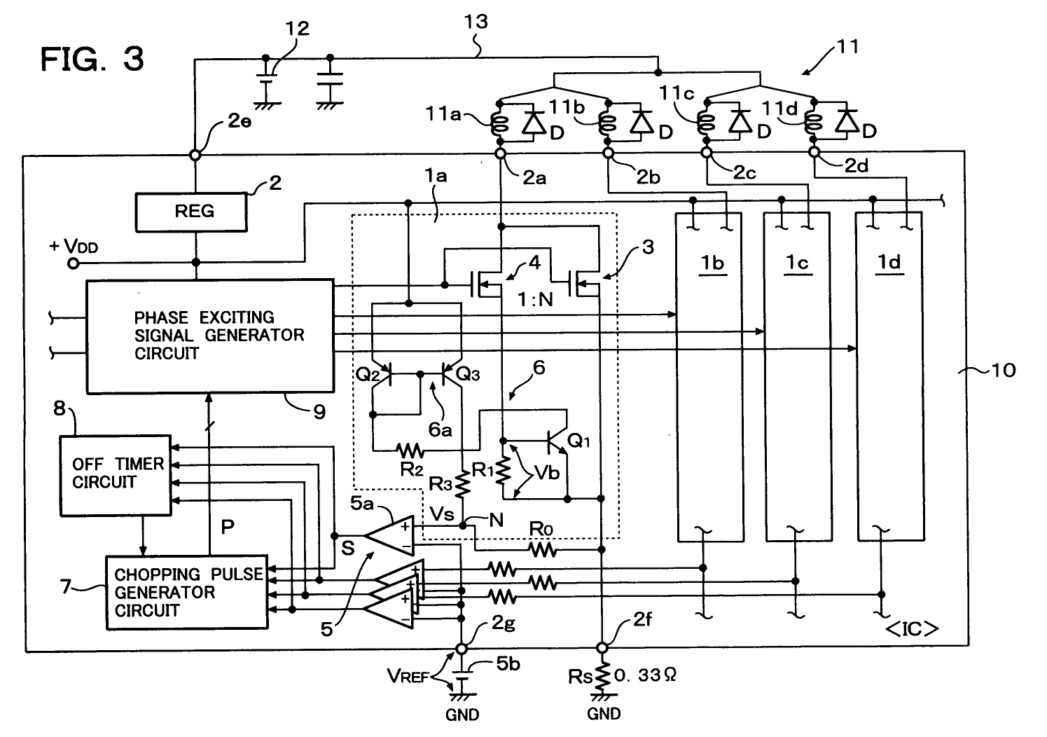

### DESCRIPTION OF REFERENCE NUMERALS AND SIGNS

1a, 1b, 1c, 1d . . . single phase drive circuit
2a, 2b, 2c, 2d . . . output terminal
3, 4 . . . N channel MOSFET power transistor
5 . . . current limiting circuit
5a . . . comparator
6 . . . over-current detection circuit
6a . . . current mirror circuit
7 . . . chopping pulse generator circuit
8 . . . OFF timer circuit
9 . . . phase exciting signal generator circuit
10 . . . stepping motor driver IC
11a, 11b, 11c, 11d . . . exciting coil
12 . . . power source
R0, Rs, R1 to R3 . . . resistor
Q1 to Q3 . . . bipolar transistor
D . . . flywheel diode

1. An over-current protection circuit of a semiconductor circuit including a power transistor for outputting current output, a first output current detection circuit and a current limiter circuit for limiting the output current by stopping the output current of the power transistor for a predetermined period in response to a first detection signal from the output current detection circuit when the output current of the power transistor reaches a predetermined limit value, comprising:
an output current detection transistor current-mirror connected to the power transistor; and
a second output current detection circuit for generating a second detection signal according to an output current of the output current detection transistor when the output current reaches a predetermined value larger than the predetermined limit value,
wherein the output current of the power transistor is cut off for the predetermined period by operating the current limiter circuit in response to the second detection signal.

2. The over-current protection circuit as claimed in claim 1, wherein the semiconductor circuit is a motor driver circuit IC, the predetermined value is set in a range within which a continuous drive of a motor by the power transistor is possible without any trouble.

3. The over-current protection circuit as claimed in claim 2, wherein the predetermined value is in a range higher than the predetermined limit value by 5% to 10% of the predetermined limit value, the output current detection circuit includes a first resistor provided externally of the IC and connected to a predetermined terminal of the IC and the first detection signal is a terminal voltage generated in the first resistor.

4. The over-current protection circuit as claimed in claim 3, wherein the current limiter circuit includes a comparator, the comparator compares the terminal voltage generated in the first resistor with a predetermined reference voltage and generates an output signal for cutting off the output current for the predetermined period according to a result of the comparison and the comparator compares a voltage signal generated according to the second detection signal with the predetermined voltage and generates the output signal according to a result of the comparison.

5. The over-current protection circuit as claimed in claim 4, further comprising a chopping pulse generator circuit and a timer circuit, wherein the predetermined period is a constant period, the timer circuit is actuated by the output signal to measure the constant period, the chopping pulse generator circuit generates a pulse every constant period set by the timer circuit and the power transistor is ON/OFF controlled by the pulse.

6. The over-current protection circuit as claimed in claim 3, wherein the output current is a sink current from an output terminal of the power transistor and the motor is driven by the sink current.

7. The over-current protection circuit as claimed in claim 6, further comprising a second resistor provided between the output current detection transistor and a reference voltage line, wherein the power transistor and the output current detection transistor are N channel MOS transistors and the second detection signal is generated correspondingly to a terminal voltage in the second resistor.

8. The over-current protection circuit as claimed in claim 7, further comprising a transistor for detecting an over-current, which is turned ON when the terminal voltage of the second resistor exceeds a certain value, and a third resistor provided within the motor driver IC between the predetermined terminal and the comparator, wherein the second detection signal is generated when the transistor is turned ON to generate a voltage higher than the predetermined reference voltage at a terminal of the third resistor.

9. The over-current protection circuit as claimed in claim 8, wherein the terminal of the over-current detection transistor at which a ground current is generated and a terminal of the second resistor connected to the reference voltage line are connected to the predetermined terminal.

10. A motor drive circuit comprising the over-current protection circuit claimed in claims 1, wherein the semiconductor circuit is an IC.

11. The motor drive circuit as claimed in claim 10, wherein the output terminal of the power transistor is connected to a stepping motor.

12. A semiconductor device comprising a motor drive circuit as claimed in claim 10.
